(19) United States
(12) Patent Application Publication
(10) Pub. No.: US 2017/0004226 A1
(43) Pub. Date: Jan. 5, 2017

(54) STRESS TESTING BY AVOIDING SIMULATIONS

(71) Applicant: SAS Institute Inc., Cary, NC (US)

(72) Inventors: Klas Jimmy Skoglund, Motala (SE); Wei Chen, Apex, NC (US)

(73) Assignee: SAS Institute Inc., Cary, NC (US)

(21) Appl. No.: 15/082,240

(22) Filed: Mar. 28, 2016

Related U.S. Application Data
(60) Provisional application No. 62/188,716, filed on Jul. 5, 2015.
(60) Provisional application No. 62/216,392, filed on Sep. 10, 2015.

(51) Int. Cl. G06F 17/50; H04L 29/08; G06F 17/18

(52) U.S. Cl. CPC G06F 17/50; G06F 17/18; H04L 67/10

(57) ABSTRACT

Systems, methods, and computer program products are provided that perform modeling and stress testing algorithms without the need for running simulations and that provide exact or approximate solutions for predicting outcomes of states and distributions of states for components of a structure. The disclosed systems, methods, and products may employ a Markov iteration approach, such as an exact Markov iteration approach or a reduced or simplified Markov iteration approach for predicting states and distributions of states for components of a structure using an algorithm that reduces solution complexity as compared to approaches that employ simulations.

### CROSS-REFERENCE TO RELATED APPLICATIONS

This application claims the benefit of and priority under 35 U.S.C. § 119(e) to U.S. Provisional Application 62/188,716, filed on Jul. 5, 2015, and U.S. Provisional Application 62/216,392, filed on Sep. 10, 2015 which are hereby incorporated by reference in their entireties.

### SUMMARY

In accordance with the teachings described herein, systems, methods, and computer program products are provided for performing modeling and stress testing algorithms without the need for running simulations. The disclosed systems, methods, and products may provide exact solutions that predict outcomes of states and distributions of states for components of a structure. The disclosed systems, methods, and products may alternatively or additionally provide approximate solutions for prediction of states and distributions of states for components of a structure using an algorithm that reduces solution complexity. Advantageously, both the exact and approximate solutions exhibit accuracy as good or greater than algorithms that employ simulations and, thus, may be performed in the absence of or in place of simulation-based stress testing algorithms. It will be appreciated that simulation-based stress testing algorithms may be computationally expensive due to the required number of simulations needed, which may be as great as 1,000, 10,000, or 100,000 or more, to obtain an accurate prediction of states and distributions of states and, thus, the disclosed systems, methods, and products provide improved processing efficiencies for performing stress testing. This advantage is further multiplied when the number of components of the structure becomes large, such as 100,000 or 1,000,000 or more, as individual simulations for each component may be required to accurately perform stress testing.

In a first aspect, stress testing systems are provided. Stress testing systems of this aspect are useful, for example, for performing modeling and generating predictions of states and state path trajectory for components of a structure. Useful stress testing systems of this aspect include those comprising one or more processors, and a non-transitory computer readable storage medium including instructions that, when executed by the one or more processors, cause the one or more processors to perform operations including: receiving a structure definition for a structure, such as a structure that includes a plurality of components, and such as a structure definition that identifies characteristics of components in the structure; determining a stress scenario specification, such as a stress scenario specification that relates to time period dependent stress conditions that affect changes to characteristics; iteratively determining transition matrices for each of a plurality of time periods and component transition histories using the stress scenario specification, for example where a transition matrix includes transition intensities, such as a transition intensity that corresponds to a likelihood that a component of the structure will change from an initial component state to a future component state within one time period; determining an initial distribution of component states at an initial time, such as by using the structure definition; and generating an output flow using the transition matrices and the initial distribution of component states, such as an output flow that provides a distribution of predicted future component states for each of the plurality of time periods.

Optionally, characteristics include a component state and a component transition history. Optionally, determining an individual transition matrix for a particular time period includes identifying allowable transitions between each component state and identifying transition intensities for each allowable transition using the stress scenario specification for the particular time period and the component transition histories. Optionally, for a system of this aspect, the operations may further include determining a time dependent growth rate, wherein generating the output flow includes using the time dependent growth rate, and wherein a time dependent growth rate provides rates at which a component characteristic increases over time. Optionally, for a system of this aspect, the operations may further include determining a time dependent decay rate, wherein generating the output flow includes using the time dependent decay rate, and wherein a time dependent decay rate provides rates at which a component characteristic decreases over time.

In another aspect, computer program products for stress testing are provided. Computer program products of this aspect are useful, for example, for performing modeling and generating predictions of states and state path trajectory for components of a structure. Useful computer program products of this aspect include those tangibly embodied in a non-transitory machine-readable storage medium and comprising instructions configured to cause a computing device, such as a computing device including one or more hardware processors, to perform operations including receiving, at the computing device, a structure definition for a structure, such as a structure that includes a plurality of components, and such as a structure definition that identifies characteristics of components in the structure; determining a stress scenario specification, such as a stress scenario specification that relates to time period dependent stress conditions that affect changes to characteristics; iteratively determining transition matrices for each of a plurality of time periods using the stress scenario specification and component transition histories, for example where a transition matrix includes transition intensities, such as a transition intensity that corresponds to a likelihood that a component of the structure will change from an initial component state to a future component state within one time period; determining an initial distribution of component states at an initial time, such as by using the structure definition; and generating an output flow using the transition matrices and the initial distribution of component states, such as an output flow that provides a distribution of predicted future component states for each of the plurality of time periods.

Optionally, characteristics include a component state and a component transition history. Optionally, determining an individual transition matrix for a particular time period includes identifying allowable transitions between each component state and identifying transition intensities for each allowable transition using the stress scenario specification for the particular time period and the component transition histories. Optionally, for a computer program product of this aspect, the operations may further include determining a time dependent growth rate, wherein generating the output flow includes using the time dependent growth rate, and wherein a time dependent growth rate provides rates at which a component characteristic increases over time. Optionally, for a computer program product of this aspect, the operations may further include determining a time dependent decay rate, wherein generating the output flow includes using the time dependent decay rate, and wherein a time dependent decay rate provides rates at which a component characteristic decreases over time.

In another aspect, computer implemented stress testing methods are provided. Methods of this aspect are useful, for example, for performing modeling and generating predictions of states and state path trajectory for components of a structure. Useful methods of this aspect include those comprising receiving, at a computing device, a structure definition for a structure, such as a structure that includes a plurality of components, and such as a structure definition that identifies characteristics of components in the structure, for example where characteristics include a component state and a component transition history; determining a stress scenario specification, such as a stress scenario specification that relates to time period dependent stress conditions that affect changes to characteristics; iteratively determining transition matrices for each of a plurality of time periods using the stress scenario specification and component transition histories, for example, where a transition matrix includes transition intensities, such as a transition intensity that corresponds to a likelihood that a component of the structure will change from an initial component state to a future component state within one time period; determining an initial distribution of component states at an initial time, such as by using the structure definition; and generating an output flow using the transition matrices and the initial distribution of component states, such as an output flow that provides a distribution of predicted future component states for each of the plurality of time periods.

Optionally, determining an individual transition matrix for a particular time period includes identifying allowable transitions between each component state; and identifying transition intensities for each allowable transition using the stress scenario specification for the particular time period and the component transition histories. Optionally, for a method of this aspect, the operations may further include determining a time dependent growth rate, wherein generating the output flow includes using the time dependent growth rate, and wherein a time dependent growth rate provides rates at which a component characteristic increases over time. Optionally, for a method of this aspect, the operations may further include determining a time dependent decay rate, wherein generating the output flow includes using the time dependent decay rate, and wherein a time dependent decay rate provides rates at which a component characteristic decreases over time.

In embodiments, a stress scenario specification provides time dependent conditions that affect changes to characteristics, and may be useful as a modeling tool to explore and evaluate various conditions that may impact the distribution of states of components of a structure. For example, the stress scenario specification may provide information about how likely a transitions between states of a component may be and may be used to evaluation conditions where particular transitions may be more likely, such as problematic and/or undesirable transitions. Optionally, determining the stress scenario specification includes receiving the stress scenario specification. Useful stress scenario specifications may be provided, for example, by external entities, such as governmental or regulatory agencies. Optionally, determining the stress scenario specification includes receiving a stress projection and generating the stress scenario specification using the stress projection. For example, the stress projection may provide macro-scale conditions for affecting the changes to characteristics of components of the structure and generating the stress scenario specification may include identifying micro-scale conditions for affecting changes to characteristics of components of the structure. Optionally, the stress scenario specification identifies predicted time period dependent stress conditions, such as stress conditions that may be useful for testing purposes and/or that may be provided by one or more external entities.

In embodiments, a transition matrix provides information relating to how likely it is that particular component states may transition to the same or other component states. A transition matrix, in embodiments, may identify allowable and non-allowable transitions. For example, an allowable transition may correspond to a change from an initial state to a subsequent state that can occur or that is permitted to occur. A non-allowable transition, for example, may correspond to a change from an initial state to a subsequent state that cannot occur or that is not permitted to occur. Such allowable and non-allowable transitions may be specified when the number and identity of states is established or defined and may be dependent on past transition histories, such as whether a component has previously or never entered a particular state. Optionally, allowable transitions may correspond to a non-zero transition intensity. Optionally, non-allowable transitions may correspond to a transition intensity of zero. Optionally, a transition intensity is a transition probability. Optionally, transition matrices are dependent on component transition histories.

Optionally, determining an individual transition matrix includes generating a component state dependent transition model; and determining transition intensities using the state dependent transition model and the stress scenario specification. Optionally, iteratively determining individual transition matrices includes evaluating a Markov state transition model. Optionally, determining an individual transition matrix includes generating a time dependent component state transition model using the stress scenario specification.

It will be appreciated that the methods, systems, and computer program products described herein may be useful for evaluating stress conditions for a variety of situations or objects. For example, a structure optionally corresponds to a group of accounts. Optionally, a component corresponds to an account. Useful component states include those that identify which of a plurality of conditions the component is associated with at a particular time. Optionally, a component transition history identifies historical component states and transitions between states for the component. Optionally, a component characteristic includes a value of a component and/or a value describing the component or a physical quantity related to the component.

The methods, systems and computer program products of the invention are useful, in embodiments, for generating an output flow, which may identify predicted future states of various components of a structure and may be dependent upon previous states or transitions or other characteristics of the components. Optionally, the output flow is used to facilitate determination of required reserves for a holder of the structure based on the definition of the structure and the stress scenario specification. Optionally, the output flow is used to facilitate determination of predicted future values for one or more components of the structure or predicted future values describing one or more components of the structure or physical quantities related to one or more components of the structure.

Advantageously, generating the output flow may optionally include generating the output flow without requiring individual simulations of predicted future characteristics for each of the components of the structure. For example, generating the output flow may include computing a Markov iteration for each of the plurality of time periods

Optionally, generating the output flow includes determining products of a first transition matrix corresponding to a first time period and the initial distribution of component states to generate a first distribution of characteristics for components of the structure after the first time period. For example, generating the output flow may include determining products of a second transition matrix corresponding to a second time period and the first distribution of characteristics for components of the structure after the first time period to generate a second distribution of characteristics for components of the structure after the second time period.

Optionally, notifications may be generated that may be transmitted to and/or displayed by a remote system. For example, a summary report identifying stress scenario specification, transition matrices, output flows, etc. may be generated, for example based on the structure definition, stress scenario specification, and/or input received, and this report may be transmitted to a remote system. Optionally, the remote system may generate a notification of the report in order to alert a user that a determination or generating process is completed. This may advantageously allow a user to remotely initialize a determination or generation processes and then be alerted, such as via a notification wirelessly received on a mobile device, when the processing is complete and a report may be available. Optionally, a report and/or results of the output flow generation may be transmitted over a network connection to a mobile or remote device.

User preferences may be identified to determine which information to include in a report or which results to be provided to a user. Such preferences may facilitate reducing the total information provided to a user, such as via a mobile device, to allow for more expedient transmission and notification. Additionally, there may be significant user requests for remote processing capacity such that a user may need to have prompt notification of completion of a request in order to queue their next request. Such a notification and report alert system may facilitate this.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The present disclosure is described in conjunction with the appended figures:

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to embodiments of the present technology.

FIG. 9 illustrates a flow chart showing an example process performed by an event stream processing engine, according to some embodiments of the present technology.

FIG. 10 illustrates an ESP system interfacing between a publishing device and multiple event subscribing devices, according to embodiments of the present technology.

FIG. 11 provides an example of a structure definition.

FIG. 12 provides an example of a transition matrix for transitions between component states.

FIG. 13 provides an example of an output flow of component state distributions.

FIG. 14 provides an example of a transition matrix for transitions between component states.

FIG. 15 provides an example of an output flow of component state distributions.

FIG. 16 provides an overview of a process for stress testing.

FIG. 17 provides a plot showing simulated output flows for one component state for a Markov case and a variety of simulation cases.

FIG. 18 provides a plot showing simulated output flows for one component state for a Markov case and a variety of simulation cases.

FIG. 19 provides a plot showing simulated output flows for one component state for a Markov case and a variety of simulation cases.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Systems depicted in some of the figures may be provided in various configurations. In some embodiments, the systems may be configured as a distributed system where one or more components of the system are distributed across one or more networks in a cloud computing system.

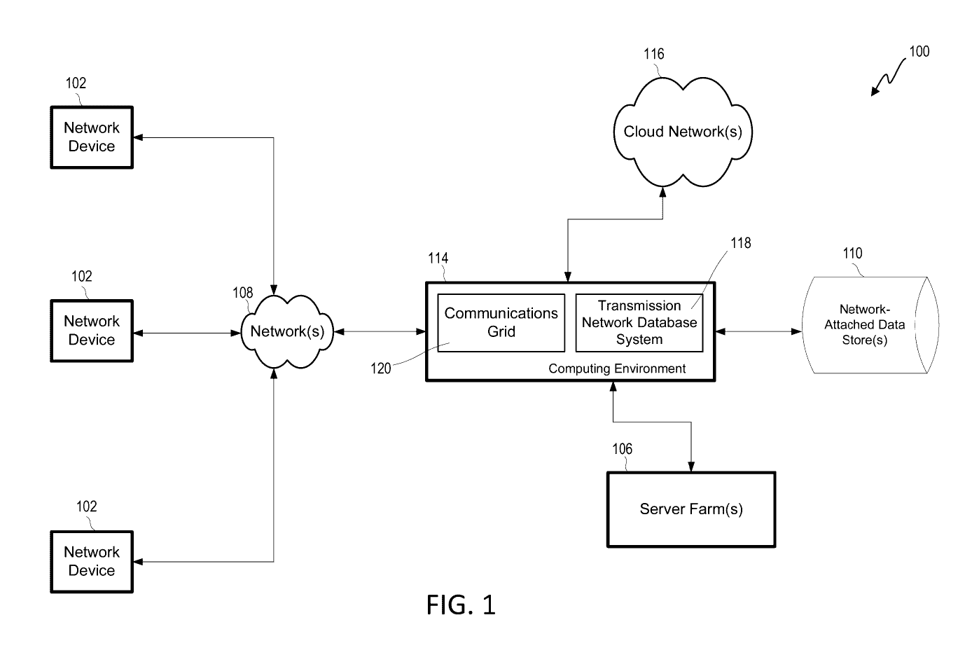

FIG. 1 is a block diagram that provides an illustration of the hardware components of a data transmission network 100, according to embodiments of the present technology. Data transmission network 100 is a specialized system that may be used for processing large amounts of data where a large number of processing cycles are required.

Data transmission network 100 may also include computing environment 114. Computing environment 114 may be a specialized or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

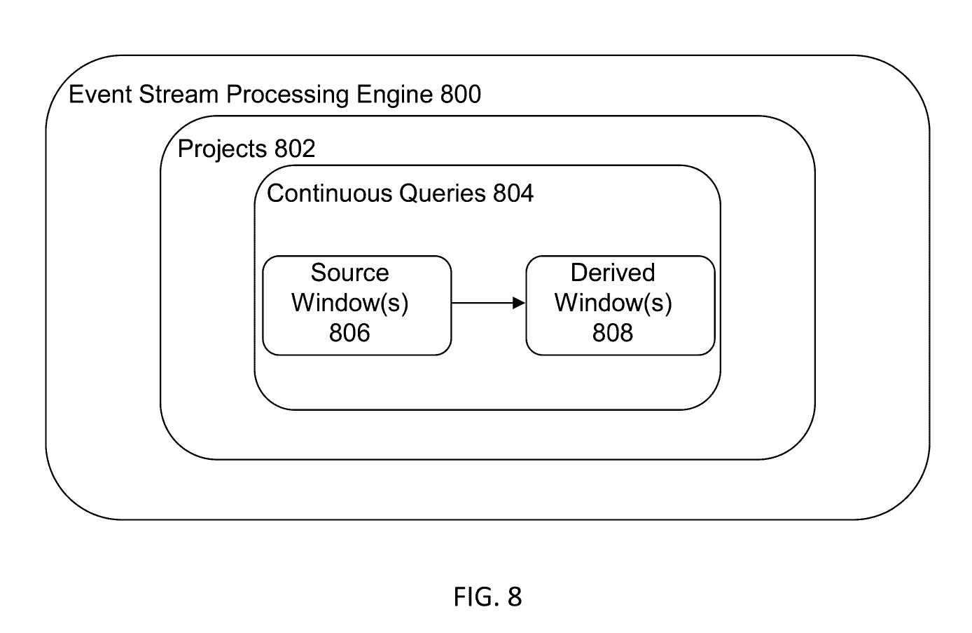

In other embodiments, network devices may provide a large amount of data, either all at once or streaming over an interval of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices, and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory computer-readable storage medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying objects being manufactured with parameter data for each object, such as colors and models) or object output databases (e.g., a database containing individual data records identifying details of individual object outputs/sales).

The unstructured data may be presented to the computing environment 114 in different forms such as a flat file or a conglomerate of data records, and may have data points and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time interval units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more sever farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system as needed. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may comprise one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, as needed, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

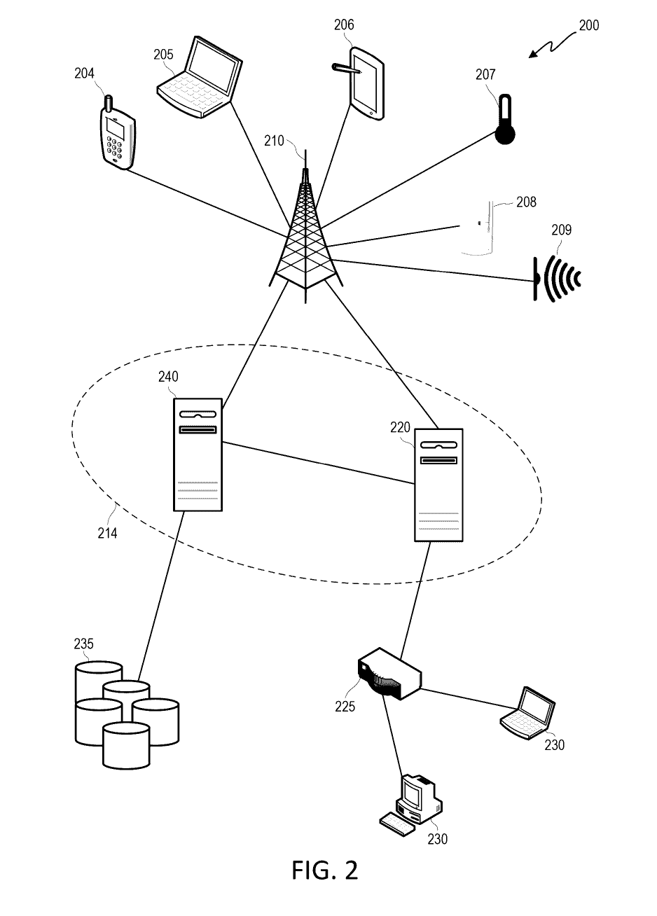

Each communication within data transmission network 100 (e.g., between client devices, between a device and connection system 150, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a Bluetooth or a Bluetooth Low Energy channel. A wired network may include a wired interface. The wired and/or wireless networks may be implemented using routers, access points, bridges, gateways, or the like, to connect devices in the computing environment 114, as will be further described with respect to FIG. 2. The one or more networks 108 can be incorporated entirely within or can include an intranet, an extranet, or a combination thereof In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and relational analytics can be applied to identify hidden relationships and drive increased effectiveness. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, electrical current, among others. The sensors may be mounted to various components used as part of a variety of different types of systems (e.g., an oil drilling operation). The network devices may detect and record data related to the environment that it monitors, and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc.

Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, and homes, among others. One or more of such devices may include one or more sensors that detect energy gain or loss, electrical input or output or loss, and a variety of other benefits. These sensors may collect data to inform users of how the energy grid, and individual devices within the grid, may be functioning and how they may be better utilized.

Network device sensors may also process data collected before transmitting the data to the computing environment 114, or before deciding whether to transmit data to the computing environment 114. For example, network devices may determine whether data collected meets certain rules, for example by comparing data or points calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operation, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., object information, client rules, etc.), technical object details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis.

For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over an interval of time for a client to determine results data based on the client's needs and rules.

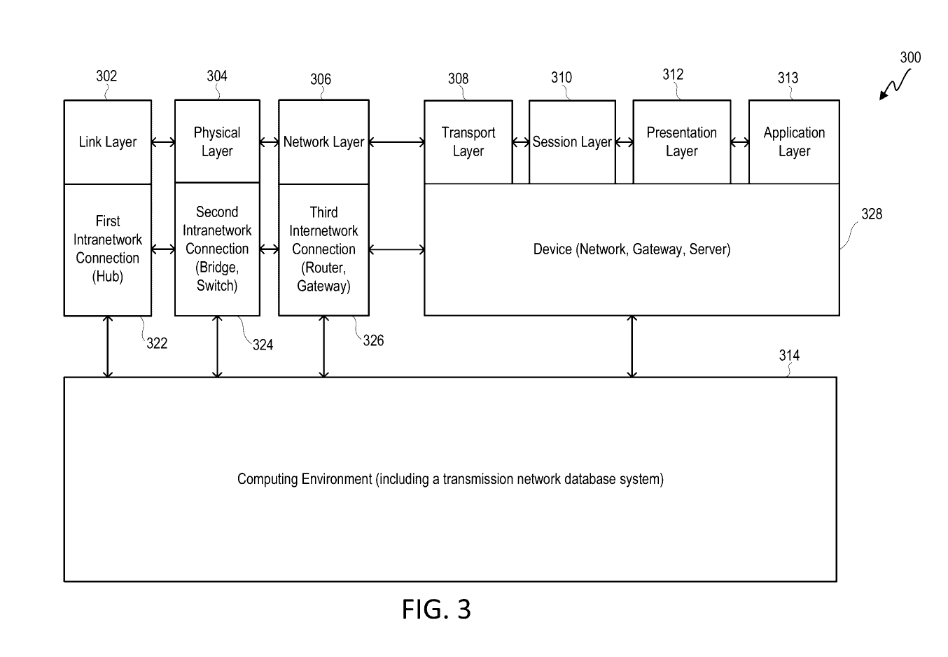

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 302-313. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data, and is the farthest layer from the user in a communications system. On the other hand, the application layer is the highest layer because it interacts directly with an application.

As noted, the model includes a physical layer 302. Physical layer 302 represents physical communication, and can define parameters of that physical communication. For example, such physical communication may come in the form of electrical, optical, or electromagnetic signals. Physical layer 302 also defines protocols that may control communications within a data transmission network.

Link layer 304 defines links and mechanisms used to transmit (i.e., move) data across a network. The link layer handles node-to-node communications, such as within a grid computing environment. Link layer 304 can detect and correct errors (e.g., transmission errors in the physical layer 302). Link layer 304 can also include a media access control (MAC) layer and logical link control (LLC) layer.

Network layer 306 defines the protocol for routing within a network. In other words, the network layer coordinates transferring data across nodes in a same network (e.g., such as a grid computing environment). Network layer 306 can also define the processes used to structure local addressing within the network.

Transport layer 308 can handle the transmission of data and the quality of the transmission and/or receipt of that data. Transport layer 308 can provide a protocol for transferring data, such as, for example, a Transmission Control Protocol (TCP). Transport layer 308 can assemble and disassemble data frames for transmission. The transport layer can also detect transmission errors occurring in the layers below it.

Session layer 310 can establish, maintain, and handle communication connections between devices on a network. In other words, the session layer controls the dialogues or nature of communications between network devices on the network. The session layer may also establish checkpointing, adjournment, termination, and restart procedures.

Presentation layer 312 can provide translation for communications between the application and network layers. In other words, this layer may encrypt, decrypt and/or format data based on data types known to be accepted by an application or network layer.

Application layer 313 interacts directly with applications and end users, and handles communications between them. Application layer 313 can identify destinations, local resource states or availability and/or communication content or formatting using the applications.

Intra-network connection components 322 and 324 are shown to operate in lower levels, such as physical layer 302 and link layer 304, respectively. For example, a hub can operate in the physical layer, a switch can operate in the physical layer, and a router can operate in the network layer. Inter-network connection components 326 and 328 are shown to operate on higher levels, such as layers 306-313. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system (DBMS), controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

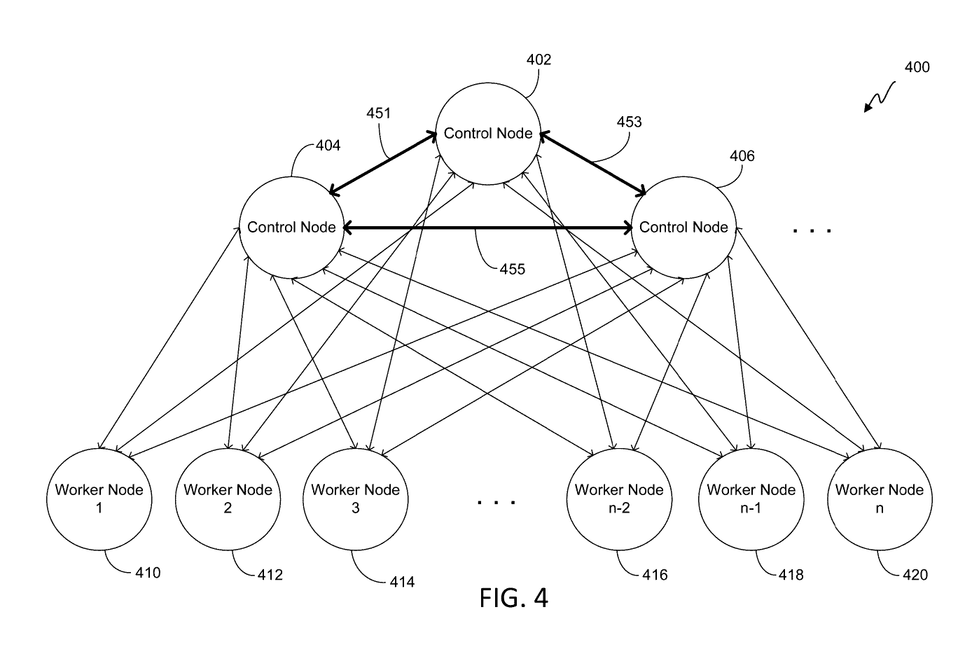

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it, and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be receive or stored by a machine other than a control node (e.g., a Hadoop data node).

Control nodes may maintain knowledge of the status of the nodes in the grid (i.e., grid status information), accept work requests from clients, subdivide the work across worker nodes, coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project code running on each node. A communication handle may be created on each node. A handle, for example, is a reference to the communicator that is valid within a single process on a single node, and the handle may be used when requesting communications between nodes.

A control node, such as control node 402, may be designated as the primary control node. A server or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most effectively and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes). The primary control node may be provided with a list of other nodes (e.g., other machines, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined interval of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recent saved checkpoint of their status and re-start the project from that checkpoint to minimize lost progress on the project being executed.

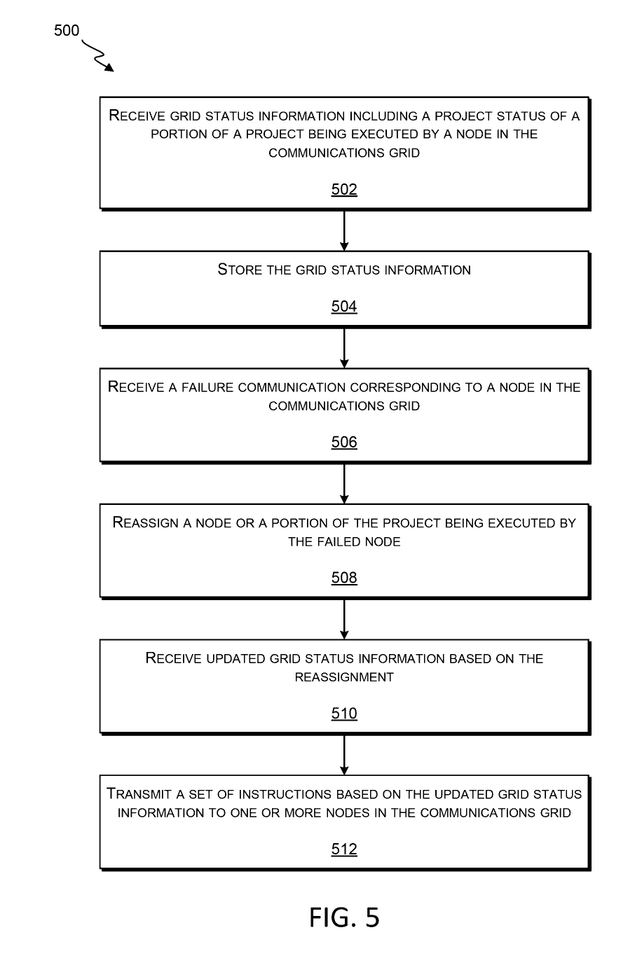

FIG. 5 illustrates a flow chart showing an example process for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

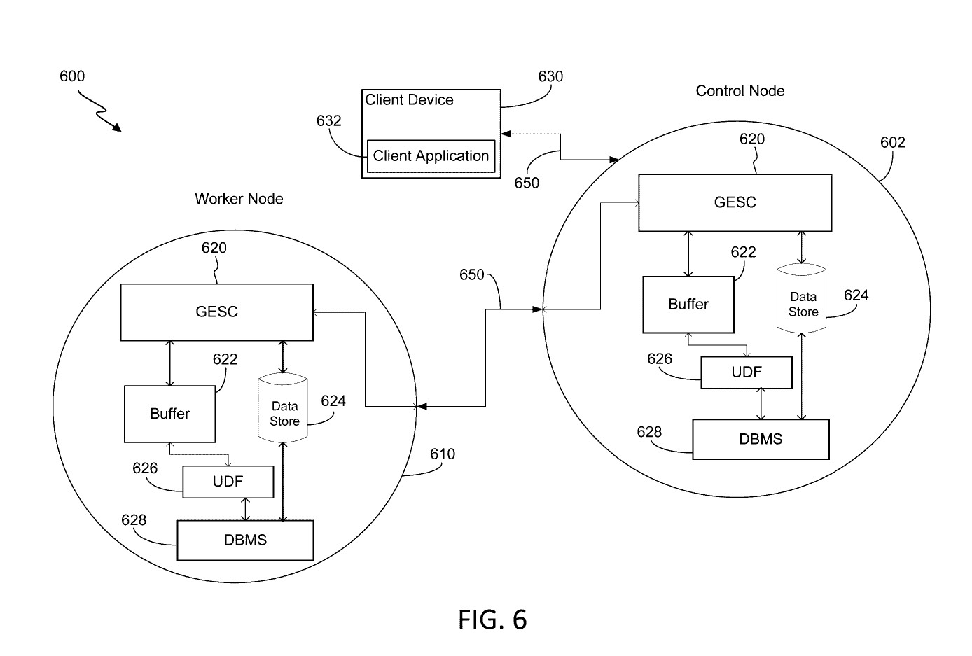

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 comprise multi-core data processors. Each node 602 and 610 includes a grid-enabled software component (GESC) 620 that executes on the data processor associated with that node and interfaces with buffer memory 622 also associated with that node. Each node 602 and 610 includes a DBMS 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DMBS 628 to transfer data to or receive data from the database stored in the data stores 624 that are handled by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DMBS 628 may control the creation, maintenance, and use of database or data structure (not shown) within a nodes 602 or 610. The database may organize data stored in data stores 624. The DMBS 628 at control node 602 may accept requests for data and transfer the appropriate data for the request. With such a process, collections of data may be distributed across multiple physical locations. In this example, each node 602 and 610 stores a portion of the total data handled in the associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

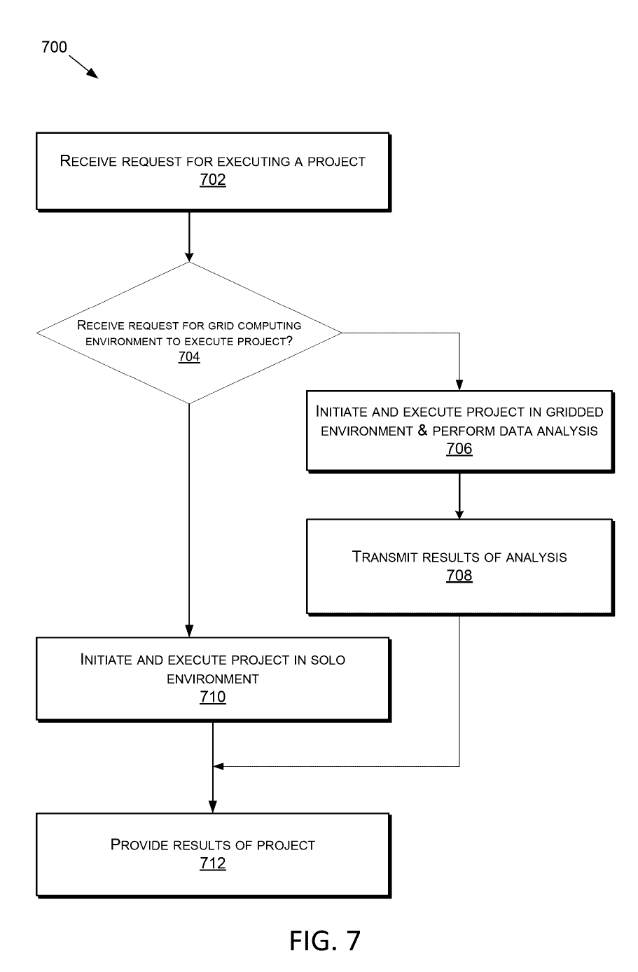

FIG. 7 illustrates a flow chart showing an example method for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project.

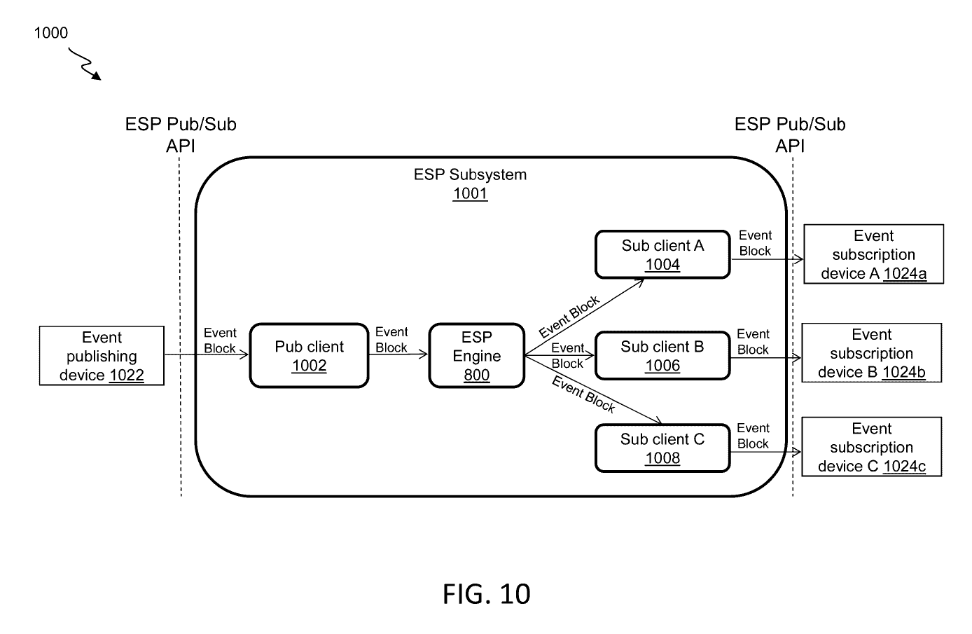

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model handled by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over an interval of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2.

The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that handles the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other techniques on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field data points and include both metadata and field data associated with an event. The metadata may include an opcode indicating if the event represents an insert, update, delete, or upsert, a set of flags indicating if the event is a normal, partial-update, or a retention generated event from retention policy handling, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

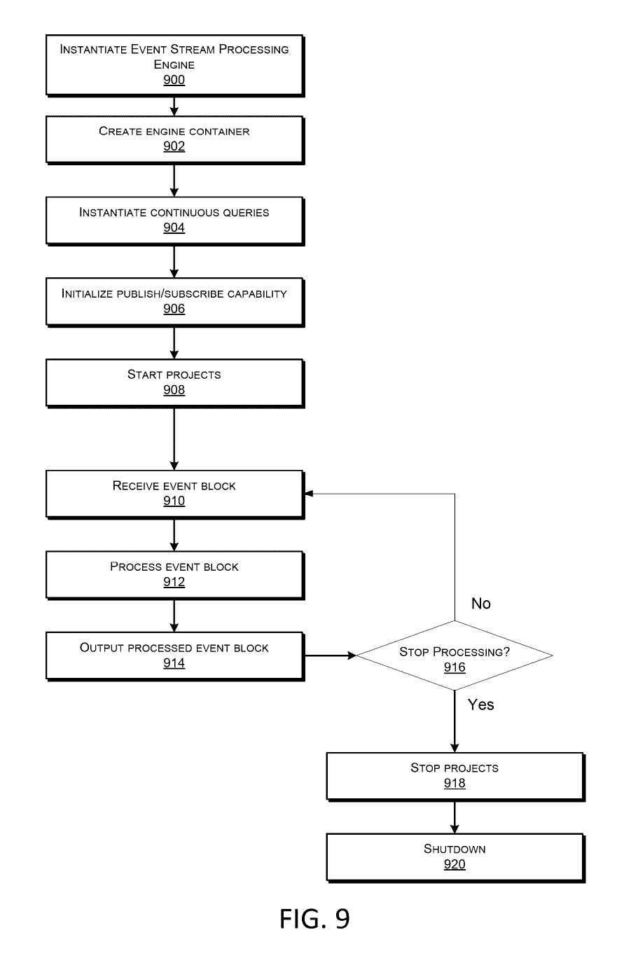

FIG. 9 illustrates a flow chart showing an example process of an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a handler for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and handling (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 1001, event publishing device 1022, an event subscribing device A 1024a, an event subscribing device B 1024b, and an event subscribing device C 1024c. Input event streams are output to ESP device 1001 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 806, and subscribing client C 808 and to event subscription device A 1024a, event subscription device B 1024b, and event subscription device C 1024c.

Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 804, subscribing client B 806, and subscribing client C 808 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a machine-readable medium operably coupled to the processor. The processor is configured to execute an ESP engine (ESPE). The machine-readable medium has instructions stored thereon that, when executed by the processor, cause the computing device to support the failover. An event block object is received from the ESPE that includes a unique identifier. A first status of the device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory machine-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory machine-readable medium.

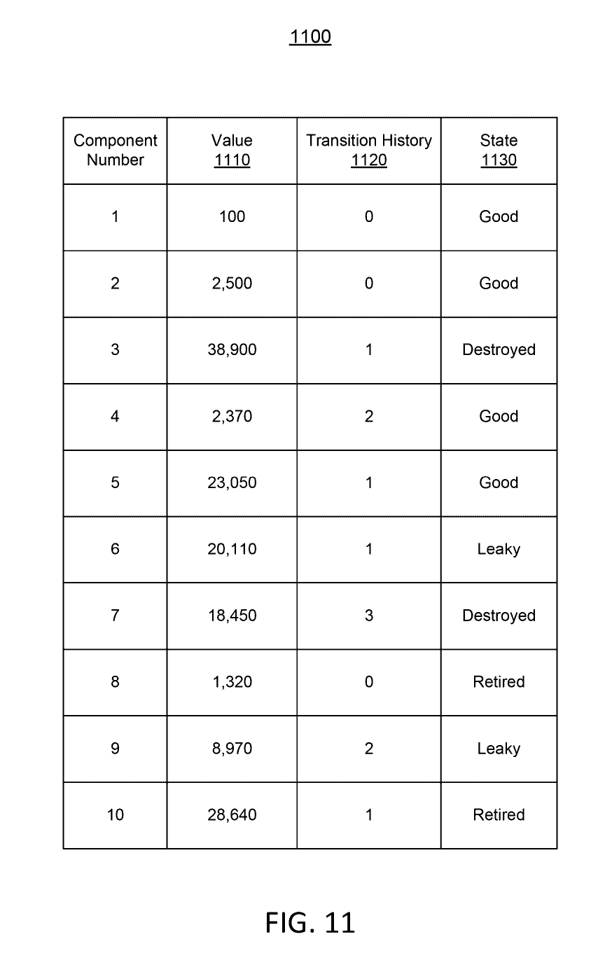

FIG. 11 provides an example of a structure definition 1100 corresponding to a structure including 10 components. Each component has one or more characteristics, including a value 1110, a transition history 1120, and state 1130. It will be appreciated that the structure may correspond to a group of components organized for individual identification such that the characteristics, transition history and state of each component can be tracked as a function of time. As an example, the components identified in structure definition 1100 correspond to tires, where the value 1110 corresponds to a distance traveled by the tire, the transition history 1120 identifies the number of times the tire has transitioned to the “Leaky” state, and the state 1130 is one of four states for each tire—Good, Leaky, Destroyed, or Retired.

The states 1130 identified in structure definition 1100 in FIG. 11 are provided as a simple example only for illustration purposes and for the purposes of explanation of how components may transition from one state to another and be tracked and have future states predicted. For example, when a tire is in operable condition and does not need any repair, it may be referred to in the “Good” state; when a tire leaks air or is otherwise damaged and/or needs repair, it may be referred to in the “Leaky” state; when a tire is damaged beyond repair, it may be referred to in the “Destroyed” state; when a tire that is not damaged beyond repair but is taken out of operation, it may be referred to in the “Retired” state.

Only certain transitions between states may be permitted for certain embodiments and, depending on the allowed transitions, these different states may be referred to as absorbing and non-absorbing or survival states. In the tire example, a tire that is in the “Good” state may next transition to the “Good” state, to the “Leaky” state, or to the “Retired” state; a “Good” tire may not transition immediately to the “Destroyed” state; thus, the “Good” state is a survival state. As another example, a tire that is in the “Leaky” state may next transition to the “Good” state, to the “Leaky” state, to the “Destroyed” state, or to the “Retired” state; thus, the “Leaky” state is also a survival state. As another example, a tire that is in the “Destroyed” state may not transition to any other state and will remain in the “Destroyed” state for all future transitions; thus, the “Destroyed” state is an absorbing state. Similarly, for example, a tire that is in the “Retired” state may not transition to any other state and will remain in the “Retired” state for all future transitions; thus, the “Retired” state is also an absorbing state. It will be appreciated that these state definitions are simplified for illustration purposes only. Depending on the structure and component type, various numbers of states exist and may exhibit allowable/non-allowable transitions between the different states the component may occupy.

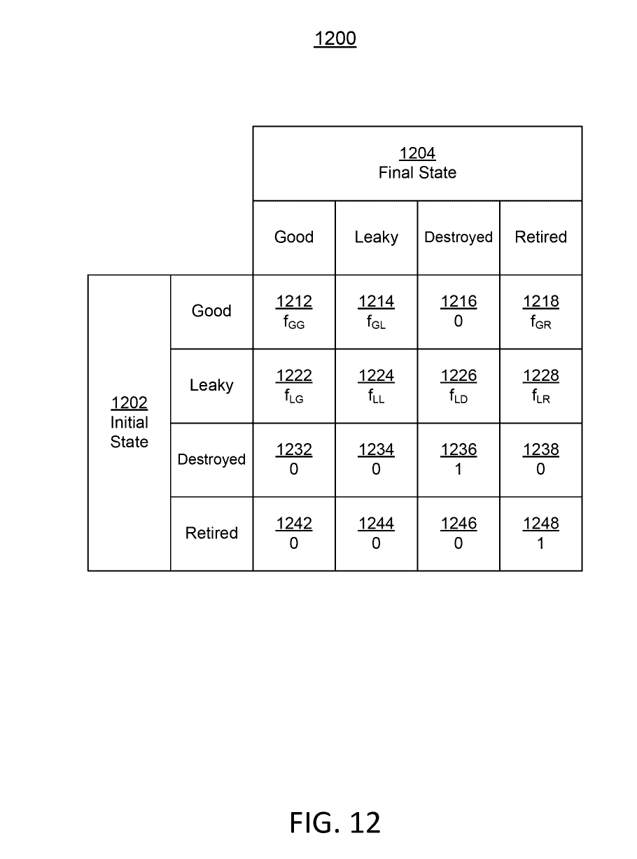

FIG. 12 provides an example of a transition matrix 1200 for transitions between component states for components identified in structure definition 1100. Here, the transition matrix identifies 1200 initial states 1202 of “Good,” “Leaky,” “Destroyed,” and “Retired” that may each possibly transition to final states 1204 of “Good,” “Leaky,” “Destroyed,” and “Retired.” As only certain transitions are not-allowed/required, as described above, certain entries in transition matrix 1200 may be either 0 or 1. For example, a tire initially in the “Good” state may not immediately transition to the “Destroyed” state, so the matrix element 1214 for this transition is 0. A tire initially in the “Destroyed” state may only transition to the “Destroyed” state, so matrix element 1232 is 0, matrix element 1234 is 0, matrix element 1236 is 1 and matrix element 1238 is 0. A tire initially in the “Retired” state may only transition to the “Retired” state, so matrix element 1242 is 0, matrix element 1244 is 0, matrix element 1246 is 0 and matrix element 1248 is 1.

For other transitions, the matrix elements may be non-zero and may reflect the likelihood of making the transition from the initial state to the final state. For example, the matrix element 1212 for transition from the “Good” state to the “Good” state is represented by f_{GG}. The matrix element 1214 for transition from the “Good” state to the “Leaky” state is represented by f_{GL}. The matrix element 1218 for transition from the “Good” state to the “Retired” state is represented by f_{GR}. The matrix element 1222 for transition from the “Leaky” state to the “Good” state is represented by f_{LG}. The matrix element 1224 for transition from the “Leaky” state to the “Leaky” state is represented by f_{LL}. The matrix element 1226 for transition from the “Leaky” state to the “Destroyed” state is represented by f_{LD}. Finally, the matrix element 1228 for transition from the “Leaky” state to the “Retired” state is represented by f_{LG}.

It will be appreciated that the values for the various matrix elements may represent the likelihood that a tire may make a particular transition. Accordingly, for various embodiments, the likelihood that particular transitions, such as those represented by matrix elements, 1212, 1214, 1218, 1222, 1224, 1226, and 1228, will be made may be dependent upon past transition history. For example, a tire in the “Good” state that has had no previous transitions to the “Leaky” state may be considered less likely to transition to the “Leaky” state than a tire that has transitioned to the “Leaky” state once or more. For certain embodiments, however, the state transition intensities or likelihoods may be independent of past transition history.

Using the techniques described herein, prediction of the distribution of tire states may be achieved through use of specific values for the transition matrix elements. In some embodiments, the values for each transition matrix element may be approximated or assumed. In some embodiments, the values for each transition matrix element may be empirically determined, such as by tracking states of tires and their transitions and determining statistical distributions that represent the likelihood of a tire with a particular transition history making a particular transition.

A tire manufacturer may be interested in predicting the rate at which tires may be destroyed or retired over the course of time. The analysis may become overly complicated because of the path dependency. That is, the projection of the destroyed or retired tires depends on the past behavior of the tires, in addition to other more complex conditions, such as driving behavior, road conditions, seasonal variations, etc. Because of the complexity of the methodology, traditional practice is to simulate a tire's behavior in a large number of paths—say 1,000 simulations or 100,000 simulations or more. The limitation of the simulation approach is a lack of accuracy and large computational requirements.

For example, when a transition probability is very low, small numbers of simulated paths may not provide significant samples for the transition. When there are a large number of states and number of future horizons, the possible paths as the combinations of states and horizons can quickly grow. Additionally, the calculation of each path is expensive. Typically, first transition probabilities are calculated at each horizon on a path using the past state behavior and other influencing conditions, then a random number is drawn to determine the next state based on the calculated transition probability. The result of the simulated paths need to be collected and tabulated. The storage and memory requirements of such processes can grow quickly as well.

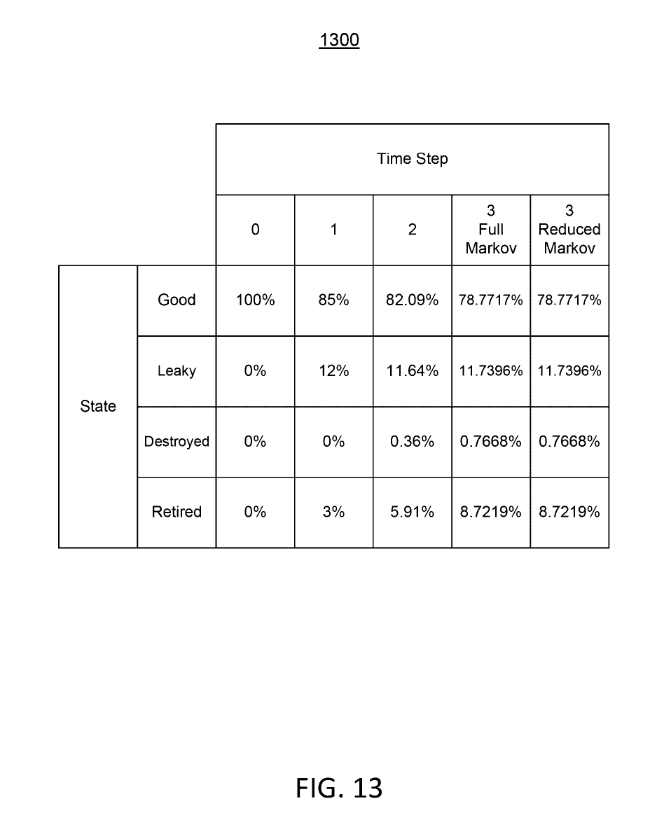

As an example, assume a tire manufacturer has a newly manufactured batch of tires, each of which are all in the “Good” state and have no past transition history. From time period to time period, each tire may transition between the different states described above and the likelihood of each transition may be dependent upon the tire's history. For example, if the tire has ever been Leaky then the chance for the tire to be destroyed is significantly higher than a tire that is always Good. FIG. 13 provides an example output flow 1300 showing the tire state distributions after each time period described in this example.

First Time Period. Starting at time 0 with 100% of the tires are in the “Good” state, and assuming the transition probabilities are: f_{GG}=85% , f_{GL}=12%, f_{GD}=0%, f_{GR}=3%, this results in the following distribution of states at the end of the first time period: Good=85%; Leaky=12%; Destroyed=0%; Retired=3%. These portions are depicted in FIG. 13.

Second Time Period. In order to calculate the expected proportion of tires in each status, a consideration of what happened in the first time period is needed and, at the end, each case will be summed to provide an overall total.

Case 1: Good-13 85% (G). In this case, the tires still have a clean history. Assuming that there is no change in the transition probabilities given above for Good tires with no Leaky history, this 85% will be further proportionated to: Good=85% of 85%=72.25% (GG); Leaky 12% of 85%=10.2% (GL); Destroyed=0% of 85%=0% (GD); Retired=3% of 85%=2.55% (GR). It will be appreciated that characters in parentheses represent the various transition histories.

Case 2: Leaky—12% (L). For the leaky portion, the tires may now transition to any of the four states. Assuming the following transitions probabilities for the Leaky state: f_{LG}=82%, f_{LL}=12%, f_{LD}=3%, f_{LR}=3%, this results in the following distribution for this portion: Good=82% of 12%=9.84% (LG); Leaky=12% of 12%=1.44% (LL); Destroyed=3% of 12%=0.36% (LD); Retired=3% of 12%=0.36% (LR).

Case 3: Destroyed—0% (D). Although all tires that are destroyed remain in this condition, no tires were after the first time period, so this portion remains at 0% (DD). No tires can be undestroyed—0% (DG, DL, DR).

Case 4: Retired—3% (R). Since all tires that are retired remain in this condition, this portion remains at 3% (RR). No tires can come out of retirement—0% (RG, RL, RD)

Summary at the end of the second time period (also summarized in FIG. 13):
Good=72.25% (GG)+9.84% (LG)+0% (DG)+0% (RG)=82.09%
Leaky=10.2% (GL)+1.44% (LL)+0% (DL)+0% (RL)=11.64%
Destroyed=0% (GD)+0.36% (LD)+0% (DD)+0% (RD)=0.36%
Retired=2.55% (GR)+0.36% (LR)+0% (DR)+3% (RR)=5.91%

Third Time Period. In this time period, things get more complicated because of the path dependency of the model. The expected behavior not only depends on what happened in the last time period, but also the tire's Leaky history. For example, the 82.09% of Good tires that start this period are apportioned between 72.25% that have no leaky history (GG) and 9.84% that have a leaky history of being leaky 1 time (LG). Similarly, the 11.64% of Leaky tires that start this period are apportioned between 10.2% that have been Leaky only 1 time (GL) and 1.44% that have been Leaky 2 times (LL).

Case 1: Good currently and Good previously—72.25% (GG). Again, the original transition values for the Good tires that have never been Leaky apply. Thus, this 72.25% will be proportionated at the end of the third time period to: Good=85% of 72.25%=61.4125% (GGG); Leaky 12% of 72.25%=8.67% (GGL); Destroyed=0% of 72.25%=0% (GGD); Retired=3% of 72.25%=2.1675% (GGR).

Case 2: Good currently and Leaky previously—9.84% (LG). Here, a different transition probability will apply, due to the past history of being leaky once before. Assuming the transition probabilities are: f_{GG}=80%, f_{GL}=17% , f_{GD}=0%, f_{GR}=3%, this results in the following distribution of states at the end of the third time period: Good=80% of 9.84%=7.872% (LGG); Leaky=17% of 9.84%=1.6728% (LGL); Destroyed=0% of 9.84%=0% (LGD); Retired=3% of 9.84%=0.2952% (LGR).

Case 3: Good currently and Destroyed previously—0% (DG). No tires can be undestroyed, so these outcomes are all 0% (DGG, DGL, DGD, DGR).

Case 4: Good currently and Retired previously—0% (RG). No tires can come out of retirement, so these outcomes are all 0% (RGG, RGL, RGD, RGR).

Case 5: Leaky currently and Good previously—10.2% (GL). Here, the transition probabilities that will apply are those for the case where tires have been leaky once, which is the same as those for Case 2 for the second time period: f_{LG}=82%, f_{LL}=12%, f_{LD}=3%, f_{LR}=3%. Thus, this 10.2% will be apportioned at the end of the third time period to: Good=82% of 10.2%=8.364% (GLG); Leaky=12% of 10.2%=1.224% (GLL); Destroyed=3% of 10.2%=0.306% (GLD); Retired=3% of 10.2%=0.306% (GLR).

Case 6: Leaky currently and Leaky previously—1.44% (LL). Here, we have tires that have been leaky twice, which may result in worse outcomes for these tires. Assuming a transition probability for twice leaky tires of: f_{LG}=78%, f_{LL}=12%, f_{LD}=7%, f_{LR}=3%, this results in the following distribution for this portion: Good=78% of 1.44%=1.1232% (LLG); Leaky=12% of 1.44%=0.1728% (LLL); Destroyed=7% of 1.44%=0.1008% (LLD); Retired=3% of 1.44%=0.0432% (LLR).

Case 7: Leaky currently and Destroyed previously—0% (DL). Since there is no population here, these outcomes are all 0% (DLG, DLL, DLD, DLR); additionally, no tires can become undestroyed, so, even if there were population here, a change of state is not permitted.

Case 8: Leaky currently and Retired previously—0% (RL). Since there is no population here, these outcomes are all 0% (RLG, RLL, RLD, RLR); additionally, no tires can come out of retirement, so, even if there were population here, a change of state is not permitted.

Case 9: Destroyed currently and Good previously—0% (GD). Since there is no population here, these outcomes are all 0% (GDG, GDL, GDD, GDR); additionally, no tires can become undestroyed, so, even if there were population here, a change of state is not permitted.

Case 10: Destroyed currently and Leaky previously—0.36% (LD). Once a tire is destroyed, it must remain destroyed, so this portion all remains destroyed, 0.36% (LDD). No change in state from destroyed to good, leaky, or retired is possible, so these outcomes are all 0% (LDG, LDL, LDR).

Case 11: Destroyed currently and Destroyed previously—0% (DD). Since there is no population here, these outcomes are all 0% (DDG, DDL, DDD, DDR); additionally, no tires can become undestroyed, so, even if there were population here, a change of state is not permitted.

Case 12: Destroyed currently and Retired previously—0% (RD). Since there is no population here, these outcomes are all 0% (RDG, RDL, RDD, RDR); additionally, no tires can come out of retirement, so, even if there were population here, a change of state is not permitted.

Case 13: Retired currently and Good previously—2.55% (GR). Once a tire is retired, it must remain retired, so this portion all remains retired, 2.55% (GRR). No change in state from retired to good, leaky, or destroyed is possible, so these outcomes are all 0% (GRG, GRL, GRD).

Case 14: Retired currently and Leaky previously—0.36% (LR). Once a tire is retired, it must remain retired, so this portion all remains retired, 0.36% (LRR). No change in state from retired to good, leaky, or destroyed is possible, so these outcomes are all 0% (LRG, LRL, LRD).

Case 15: Retired currently and Destroyed previously—0% (DR). Since there is no population here, these outcomes are all 0% (DRG, DRL, DRD, DRR); additionally, no tires can become undestroyed, so, even if there were population here, a change of state is not permitted.

Case 16: Retired currently and Retired previously—3% (RR). Once a tire is retired, it must remain retired, so this portion all remains retired, 3% (RRR). No change in state from retired to good, leaky, or destroyed is possible, so these outcomes are all 0% (RRG, RRL, RRD).

Summary at the end of the third time period (total values also shown in FIG. 13):

$$Good = \begin{matrix} \\ 61.4125 \% \\ ( GGG )\end{matrix} + \begin{matrix} \\ 7.872 \% \\ ( LGG )\end{matrix} + \begin{matrix} \\ 0 \% \\ ( DGG )\end{matrix} + \begin{matrix} \\ 0 \% \\ ( RGG )\end{matrix} + \begin{matrix} \\ 8.364 \% \\ ( GLG )\end{matrix} + \begin{matrix} \\ 1.1232 \% \\ ( LLG )\end{matrix} + \begin{matrix} \\ 0 \% \\ ( DLG )\end{matrix} + \begin{matrix} \\ 0 \% \\ ( RLG )\end{matrix} + \begin{matrix} \\ 0 \% \\ ( GDG )\end{matrix} + \begin{matrix} \\ 0 \% \\ ( LDG )\end{matrix} + \begin{matrix} \\ 0 \% \\ ( DDG )\end{matrix} + \begin{matrix} \\ 0 \% \\ ( RDG )\end{matrix} + \begin{matrix} \\ 0 \% \\ ( GRG )\end{matrix} + \begin{matrix} \\ 0 \% \\ ( LRG )\end{matrix} + \begin{matrix} \\ 0 \% \\ ( DRG )\end{matrix} + \begin{matrix} \\ 0 \% \\ ( RRG )\end{matrix} = 78.7717 \%$$

$$Leaky = \begin{matrix} \\ 8.67 \% \\ ( GGL )\end{matrix} + \begin{matrix} \\ 1.6728 \% \\ ( LGL )\end{matrix} + \begin{matrix} \\ 0 \% \\ ( DGL )\end{matrix} + \begin{matrix} \\ 0 \% \\ ( RGL )\end{matrix} + \begin{matrix} \\ 1.224 \% \\ ( GLL )\end{matrix} + \begin{matrix} \\ 0.1728 \% \\ ( LLL )\end{matrix} + \begin{matrix} \\ 0 \% \\ ( DLL )\end{matrix} + \begin{matrix} \\ 0 \% \\ ( RLL )\end{matrix} + \begin{matrix} \\ 0 \% \\ ( GDL )\end{matrix} + \begin{matrix} \\ 0 \% \\ ( LDL )\end{matrix} + \begin{matrix} \\ 0 \% \\ ( DDL )\end{matrix} + \begin{matrix} \\ 0 \% \\ ( RDL )\end{matrix} + \begin{matrix} \\ 0 \% \\ ( GRL )\end{matrix} + \begin{matrix} \\ 0 \% \\ ( LRL )\end{matrix} + \begin{matrix} \\ 0 \% \\ ( DRL )\end{matrix} + \begin{matrix} \\ 0 \% \\ ( RLL )\end{matrix} = 11.7396 \%$$

$$Destroyed = \begin{matrix} \\ 0 \% \\ ( GGD )\end{matrix} + \begin{matrix} \\ 0 \% \\ ( LGL )\end{matrix} + \begin{matrix} \\ 0 \% \\ ( DGD )\end{matrix} + \begin{matrix} \\ 0 \% \\ ( RGL )\end{matrix} + \begin{matrix} \\ 0.306 \% \\ ( GLD )\end{matrix} + \begin{matrix} \\ 0.1008 \% \\ ( LLD )\end{matrix} + \begin{matrix} \\ 0 \% \\ ( DLD )\end{matrix} + \begin{matrix} \\ 0 \% \\ ( RLD )\end{matrix} + \begin{matrix} \\ 0 \% \\ ( GDD )\end{matrix} + \begin{matrix} \\ 0.36 \% \\ ( LDD )\end{matrix} + \begin{matrix} \\ 0 \% \\ ( DDD )\end{matrix} + \begin{matrix} \\ 0 \% \\ ( RDD )\end{matrix} + \begin{matrix} \\ 0 \% \\ ( GRD )\end{matrix} + \begin{matrix} \\ 0 \% \\ ( LRD )\end{matrix} + \begin{matrix} \\ 0 \% \\ ( DRD )\end{matrix} + \begin{matrix} \\ 0 \% \\ ( RRD )\end{matrix} = 0.7668 \%$$

$$Retired = \begin{matrix} \\ 2.1675 \% \\ ( GGR )\end{matrix} + \begin{matrix} \\ 0.2952 \% \\ ( LGR )\end{matrix} + \begin{matrix} \\ 0 \% \\ ( DGR )\end{matrix} + \begin{matrix} \\ 0 \% \\ ( RGR )\end{matrix} + \begin{matrix} \\ 0.306 \% \\ ( GLR )\end{matrix} + \begin{matrix} \\ 0.0432 \% \\ ( LLR )\end{matrix} + \begin{matrix} \\ 0 \% \\ ( DLR )\end{matrix} + \begin{matrix} \\ 0 \% \\ ( RLR )\end{matrix} + \begin{matrix} \\ 0 \% \\ ( GDR )\end{matrix} + \begin{matrix} \\ 0 \% \\ ( LDR )\end{matrix} + \begin{matrix} \\ 0 \% \\ ( DDR )\end{matrix} + \begin{matrix} \\ 0 \% \\ ( RDR )\end{matrix} + \begin{matrix} \\ 2.55 \% \\ ( GRR )\end{matrix} + \begin{matrix} \\ 0.36 \% \\ ( LRR )\end{matrix} + \begin{matrix} \\ 0 \% \\ ( DRR )\end{matrix} + \begin{matrix} \\ 3 \% \\ ( RRR )\end{matrix} = 8.7219 \%$$

A similar calculation can be applied to the fourth time period. But this time, the number of starting cases is 64 and there will be 256 outcomes, although these numbers will be practically reduced due to the variety of starting cases that have zero population. As the number of horizons grows, say to 8 time periods, the number of possible paths grows very quickly. In this example, there were only 4 states, of which two states were absorbing states and two states were survival states. Absorbing states tend to simplify the analysis, as the absorbing states need not be explicitly treated, as was done above, and may be simply carried forward and added to by portions of the survival states that contribute to the absorbing states. In more practical examples, the total number of states may be significantly more, magnifying the complexity.

The above example corresponds to a full or exact Markov iteration approach for solving the future states exactly provided that suitable transition matrices can be derived. The full Markov iteration approach provides a mathematically accurate view of the expected future states. When the number of projection horizons is not large, this approach may be more efficient than simulations. For a large number of horizons, however, the number of paths may quickly explode and make the problem intractable. In such cases, simulation may also not necessarily be a suitable solution because the approximation of the simulation may lose accuracy very quickly.

As an alternative to the exact Markov iteration approach described above, a reduced Markov iteration approach is provided. In embodiments, the reduced Markov iteration approach relies on key state path indicators and transition models may be built based on this information. For example, the first iteration in the reduced Markov approach may be the same as the full

Markov approach described above. Additionally, the second iteration in the reduced Markov approach may be the same as the full Markov approach.

For the third time period, the approach changes. Part of the survival portion has a “dirty” history, meaning the tire was Leaky at some point. For example, the 82.09% to start the third time period includes 72.25% with a “clean” (never Leaky) history and 9.84% that is dirty. In this time period, the following are considered:

Case 1: Clean Good (i.e., Good in both first and second time periods, GG). The expected portion from above in this case is 72.25%. The probability that these tires go to each status in the third time period is still driven by the clean history behavior given above (f_{GG}=85%, f_{GL}=12% , f_{GD}=0%, f_{GR}=3%). Applying these probabilities results in 61.4125% Good, 8.67% Leaky, 0% Destroyed, and 2.1675% Retired.

Case 2: Dirty Good (i.e., Good in second time period, but leaky in the first, LG). Although this portion starts from the “Good” portion, it is expected to be somewhat more likely to end up Leaky than the Clean Good from Case 1 above because of the Leaky history. At the end of the second period this portion was 9.84%. The clean history behavior given above cannot be used, but instead the following transition values are used, as described above: f_{GG}=80%, f_{GL}=17%, f_{GD}0%, f_{GR}=3%. Applying these results in 7.872% Good, 1.6728% Leaky, 0% Destroyed, and 0.2952% Retired.

Case 3: Leaky currently after a Good first time period (GL). This portion corresponds to 10.2% from the second period. Assuming that the original Leaky state transition values apply (f_{LG}=82%, f_{LL}=12%, f_{LD}=3%, f_{LR}=3%), this portion results in 8.364% Good, 1.224% Leaky, 0.306% Destroyed, and 0.306% Retired. For the reduced Markov approach, the 8.364% Good here will be combined with the 7.872% Good from the second case as “Good” with Leaky history (dirty Good).

Case 4: Leaky currently after a first Leaky period (LL). This portion corresponds to 1.44% and may have different behavior than tires that have a history including “Good” states. The transition probabilities for this portion can be the same as for the full Markov approach (f_{LG}=78%, f_{LL}=12%, f_{LD}=7%, f_{LR}=3%). This results in this portion transitioning to 1.1232% Good, 0.1728% Leaky, 0.1008% Destroyed, 0.0432% Retired. Again, the Good portion will be combined with the above dirty Good portions since this portion has a Leaky history. In embodiments, it may be useful to create a new indicator for frequently Leaky or only keep ever Leaky as the only indicator. In this example, only one ever Leaky indicator is sufficient.

Explicit treatment of the Destroyed or Retired portions are no longer necessary and these portions can be simply added up. The Destroyed portion at the end of the third period is thus, 0.36% (from period 2)+0.306% (from Case 3)+0.1008% (from Case 4)=0.7668%. The Retired portion at the end of the third period is thus, 5.91% (from period 2)+2.1675% (from Case 1)+0.2952% (from Case 2)+0.306% (from Case 3)+0.0432% (from Case 4)=8.7219%.

The other outcomes of interest are clean Good, dirty Good, and Leaky. The clean Good portion at the end of the third period is 64.4125% (from Case 1). The dirty Good portion at the end of the third period is 7.872% (from Case 2)+8.364% (from Case 3)+1.1232 (from Case 4)=17.3592%. Altogether, the Good portions total 78.7717%. The Leaky portion at the end of the third period is 8.67% (from Case 1)+1.6728% (from Case 2)+1.224% (from Case 3)+0.1728% (from Case 4)=11.7396. These results are summarized in FIG. 13.

For the fourth and subsequent time periods for the reduced Markov approach, only 5 cases need to be considered—Clean Good, Dirty Good, Leaky, Destroyed, Retired. It will be appreciated that this is a considerable reduction in number of cases to consider versus the full Markov approach.

It will be appreciated that the description provided above, where the components of a structure correspond to tires, is just an example. A variety of other component types may be used, such as other tangible physical products or even fiscal products, such as loans, accounts, or other assets, and/or where the structure corresponds to a portfolio. Component characteristics may include an account value, an account delinquency history, an account state, etc. Use of the full and reduced Markov iteration approaches for such components and structures may be beneficial for allowing an entity, such as a financial institution, or other holding entity, to perform stress testing on the accounts in order to predict future component values for various stress scenarios in order to determine required resources, such as capital, for example, to be held so that appropriate regulations are complied with.

The following example provides details of the prediction of component values for a financial instrument. In this analysis, the expected loss and prepayment at each time period (e.g., 1 quarter or 3 months) over a loan (the component) having a life of 4 time periods are determined. As with the tire example provided above, the analysis may become complicated due to path dependency. That is, the projection of the future states of the component depends on the information of past behavior of the component (in addition to other component or borrower attributes and macro scale or macro level scenario). Due to the complexity of the methodology, one practice is to simulate a component's behavior in, for example, 1000 paths. The limitation of the simulation approach includes a lack of accuracy and large computational requirements.

For example, when a transition probability is very low, small numbers of simulated paths may not provide significant samples for the transition. When there are a large number of states and number of future horizons, the possible paths as the combination of states and horizons can quickly grow. Accordingly, simulation techniques may require a large number of simulations to explore all possible paths. For purposes of illustration, however, the following example includes only 4 states and 4 time periods.

The calculation of each simulated path is computationally expensive. The storage and memory requirements for the simulations may quickly grow as well. Typically, transition probabilities are first calculated at each horizon on a path using the past behavior, attributes, and scenario. Then, a random number is drawn to determine the next state based on the calculated transition probability. Based on the state, models are run to calculate the loss and payments. The results of the simulated paths need to be collected and then applied to generate the expectation.

The following description begins with a full (exact) Markov iteration approach and then illustrates a reduced Markov approach. At each horizon, a fraction of the component may be proportionated into different states based on the calculated transition probability conditional on the path leading to this portion of the component. Conditional on the state, expectation projections for absorbing states may be calculated. The survival states are then analyzed for the next horizon.

The full Markov iteration approach generates the exact mathematical results, but the number of cases can grow very quickly, due to bifurcations of each surviving state leading to a new set of states in the next horizon. The full Markov approach may be useful for a small number of horizons only.

The reduced Markov iteration approach provided may be more tractable, but may operate with a model that does utilize the full state history but only key indicators, such as ever delinquent or time since last delinquency. In the reduced Markov iteration approach, full expansion of the cases may not be required.

The full and reduced Markov approaches are described in detail by U.S. Provisional Application 62/188,716, filed on Jul. 5, 2015, and U.S. Provisional Application 62/216,392, filed on Sep. 10, 2015. These applications are hereby incorporated by reference in their entireties. Additionally, a manuscript entitled “The Application of Credit Risk Models to Macroeconomic Regulatory Stress Testing” by Jimmy Skoglund and Wei Chen and available at http://ssrn.com/abstract=2605862 or http://dx.doi.org/10.2139/ssrn.2605862 provides details of the full and reduced Markov approach, and is hereby incorporated by reference in its entirety.

The example begins with a 4 time period loan (the component) of value 100 in good status. A payment or duty may be due every time period. The actions that may occur are satisfying the duty on time, missing a duty, or satisfying all duties. During the one year life, the available states correspond to: Current (C)—the duty is met; Delinquent (L)—the duty is missed; Default (D)—two duties in a row are missed; Prepay (P)—all duties are satisfied in advance at any time. Once the component reaches state P or state D, it is considered terminated.

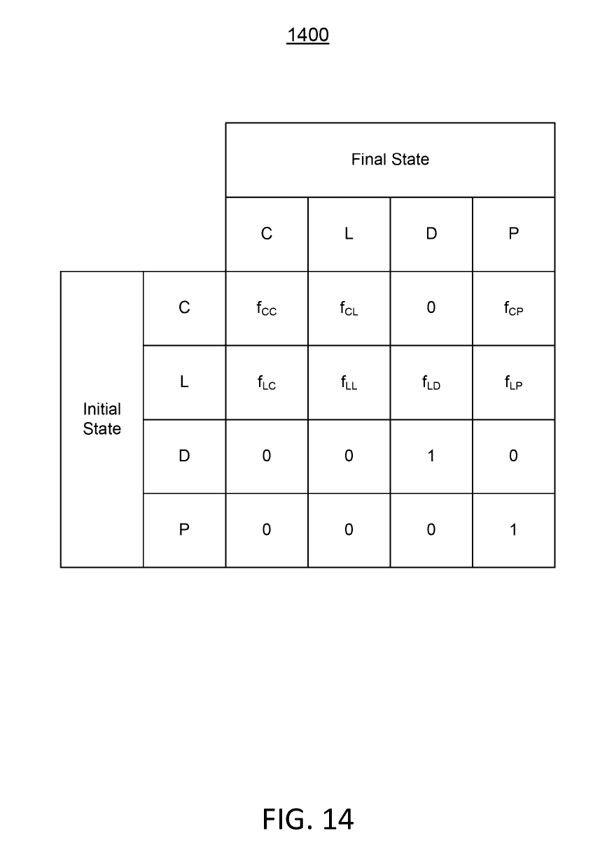

From time period to time period, the component transitions between the 4 states and may be driven by past component behavior (state experienced), attributes and macro scale scenarios. For example, if the component ever has missed a duty, then the chance for another to be missed is significantly higher than if all were on-time. On the other hand, if the component is always C and on time, then it is likely to go to state P. The transitions can be summarized by the transition matrix 1400 depicted in FIG. 14.

Full Markov Iteration Approach—1^{st} time period. Given the current on-time duty status the transition probabilities for the first time period are assumed to be the following (Clean History Transition): f_{CC}=80%; f_{CL}=10%; f_{CP}=10%. This means that at the end of the first time period, the 100 can be expected to be proportionated to the following: C=80 C, L=10, P=10.

2^{nd} time period. In order to calculate the expected proportions in each state, what happened in the first time period is used.

Case 1: C=80. In this case the component still has a “clean” history. Assuming there is no change in the component attributes and macro level situation, the same “Clean History Transition” transition probabilities apply. That means the 80 is expected to be further proportionated to: CC=64, CL=8, CP=8.

Case 2: L=10. For this portion, it can come back to C by meeting the first time period and second time period duties, or only satisfy the last missed duty but miss the next duty so it is still considered as L, or miss the duty again and go to D, or satisfy all duties and go to P. Assuming the following “L Transition” transition probabilities: f_{LC}=10%; f_{LL}=20%; f_{LD}=60%; f_{LP}=10%, at the end of the second time period the 10 is proportionated to LC=1, LL=2, LD=6, LP=1.

Case 3: P=10. The component terminates at the end of the first time period, so no transitions occur for this portion.

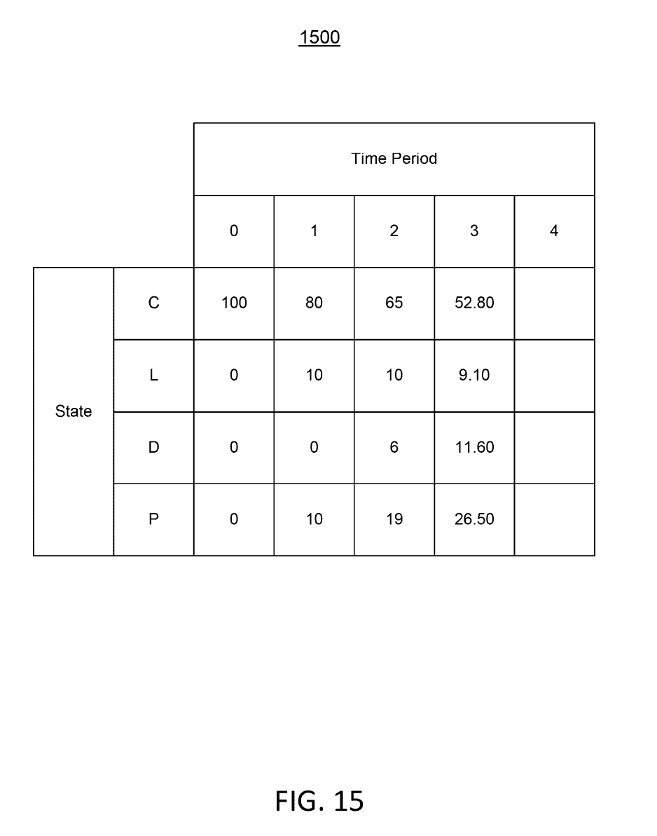

In summary, at the end of the second time period, the 100 value of the component at time 0, with 10 P in the first time period would have expected proportions as: C=65 (CC=64, LC=1), L=10 (CL=8, LL=2), D=6 (LD=6) and P=9 (CP=8, LP=1), so total P at the end of the second time period is 19. The output flow 1500 showing these proportions is depicted in FIG. 15.

3^{rd} Quarter. In this time period, things get more complicated because of the path dependency of the model. The expected behavior of the component not only depends on what happened in the last time period but also on the state history. For example, of the 65 C portion to start at the end of the 2^{nd} time period, 64 has a clean history and 1 was once L. The further expected proportion evolution will be different for these portions.

Case 1: Clean C, i.e., never been L; that is, C in both 1^{st} and 2^{nd} quarters (CC). The expected portion to start for this case is 64. The probability that this goes to each status in the 3^{rd} time period is still driven by the “Clean History Transition” transition probabilities. Applying the transition probabilities results in CCC=51.20, CCL=6.40, CCP=6.40.

Case 2: Dirty C, i.e., C in the 2^{nd} quarter, but L in the 1^{st} quarter (LC). Although this portion starts from the C state, it is expected to be more likely to be L again than the clean C in case 1. The expected portion to start for this case is 1. The “Clean History Transition” probabilities may not be used again, but a different set of transitions functions may be used: f_{CC}=60%; f_{CL}=30%; f_{CP}=10%. Thus, in the 3^{rd} quarter, the 1 results in LCC=0.60, LCL=0.30, LCP=0.10.

Case 3: 2^{nd} time period L from a1^{st} time period C (CL). This portion begins with 8. Assuming the same L transition probabilities, this 8 will result in the following proportions: CLC=0.80, CLL=1.60, CLD=4.80, CLP=0.80.

Case 4, both 1^{st} and 2^{nd} quarters are L (LL). This corresponds to 2. This portion of the component may have a different behavior than case 3 because it is likely the representative component that has a habit of missing duties, but has less intention to go to state D or is attempting to avoid state D. Assuming the transition probabilities for this portion are: f_{LC}=10%; f_{LL}=40%; f_{LD}=40%; f_{LP}=10%. Thus, in the 3^{rd} time period, the 2 results in LLC=0.20, LLL=0.80, LLD=0.80, LLP=0.20.

Note that all the D or P portions may no longer be treated explicitly, since the states are absorbing and may be carried over or are considered terminated. The 75 (C plus L) portion at the end of the 2^{nd} time period now result in the following at the end of the 3^{rd} time period: 52.80 C (CCC=51.20, CLC=0.80, LCC=0.60, LLC=0.20), 9.10 L (CCL=6.40, LCL=0.30, CLL=1.60, LLL=0.80), 5.60 D (CLD=4.80, LLD=0.80), and 7.50 P (CCP=6.40, LCP=0.10, CLP=0.80, LLP=0.20). The total D portion thus becomes 11.60 and the total P portion becomes 26.50.

A similar calculation can be applied to the 4^{th} time period for the surviving portion of 61.90 (52.80 C+9.10 L) as was applied in the 3^{rd} time period. In the 4^{th} time period, the number of cases will grow with the combination of states (27 paths): CCCC, CCLC, CLCC, CLLC, CCCL, CLCL, CCLL, CLLL, CCLD, CLLD, CCCP, CLCP, CCLP, CLLP, LCCC, LCLC, LLCC, LCCL, LLCL, LCLL, LLLL, LCLD, LLLD, LCCP, LLCP, LCLP, LLLP.

It will be appreciated that as the number of horizons grows (e.g. to 8 time periods), the number of possible paths will increase rapidly. On the other hand, the number of paths may also grow quickly with number of survival states, as it may not be needed to treat the absorbing states explicitly, but each survival state may need to be treated for all possible outcomes. In this example, there are only two survival states: C and one-period L, because the component only has one year of life. In other embodiments, for components that have lives of many time periods, histories of 3 time periods L or 4 time periods L may be considered to be state D, which means the survival states may include: C, one time period L, two time periods L, and 3 time periods L, if 3 time periods L is considered as D.

The full Markov iteration approach provides a mathematically accurate view of the fractions expected to enter state D, expected to enter state P and expected duty flows (considering flows from all possible states). When the number of projection horizons is not large, this approach may be more efficient than simulations (at the 3^{rd} horizon in this example, there are 14 paths, and at the 4^{th} horizon there are 27 paths). For a large number of horizons, the number of paths may become large and make the problem intractable. In such case, simulations may also not be a tenable solution because the approximation of the simulation may lose accuracy very quickly.

A reduced Markov iteration approach may instead be utilized. Such an approach may rely on key indicators, such as if the component has ever been one time period L or two time periods L and transition models may be built that are based on such information in addition to the macro level conditions and other component attributes. This kind of indicator driven models may be used in simulation approaches as well, but the reduced Markov iteration approach described here may dramatically reduce the computational burden while providing at least the same accuracy as the simulation approach.

Reduced Markov Iteration Approach. The 1^{st} and 2^{nd} time periods for this approach may be the same as the full iteration example above. For the 3^{rd} time period, part of the survival portion of the component has a history of being in state L at some point (dirty). For example, of the 65 C portion to start at the end of the 2^{nd} time period, 64 has a clean history and 1 was L once.

Case 1: Clean C, i.e., never been L (C in both 1^{st} and 2^{nd} time periods (CC)). The expected portion in this case is 64. The probability that this goes to each status in the 3^{rd} time period is still driven by the clean history behavior given the fixed component attribution and macro scale conditions and history using the “Clean History Transition” probability functions. Applying the transition probability to the CC=64 results in 51.20 C, 6.40 L, and 6.40 P, all conditional on clean history.

Case 2: Dirty C, i.e., C in the 2^{nd} time period but L in the 1^{st} time period (LC). Although this portion of the component starts from the C state, it is expected to be more likely to be L again than the clean C from case 1, due to the history of entering state L. At the end of the 2^{nd} quarter, this portion of the component was LC=1. The “Clean History Transition” should not be used again, but a different set of transition functions may be used to derive the “Dirty C Transition”: f_{CC}=60%, f_{CL}=30%, f_{CP}=10%. Therefore, in the 3^{rd} time period, this 1 results in 0.60 C, 0.30 L, and 0.10 P, all conditional on a history of entering state L.

Case 3: 2^{nd} quarter L from a 1^{st} quarter C (CL). At the end of the 2^{nd} time period, this portion of the component was 8. Assuming that the same L transition for the unchanged component attributes and macro level conditions can be used, this 8 will result in the following in the 3^{rd} time period: 0.80 C, 1.60 L, 4.80 D, and 0.80 P. However, this 0.80 C portion is going to be combined with the 0.60 C in the second case as “C with L history”, i.e., dirty C.

Case 4: Both 1^{st} and 2^{nd} time periods are L. This corresponds to LL=2 at the end of the 2^{nd} time period. This portion of the component may have a different behavior than case 3 because it may be likely that the representative component of this portion is getting in a habit of missing duties but has less intention to go to state D or is struggling hard to avoid state D. Assuming that the transition probabilities for this portion are driven by f_{LC}=10%, f_{LL}=40%, f_{LD}=40%, f_{LP}=10%, the LL=2 portion of the component becomes, at the end of the 3^{rd} time period: 0.20 C, 0.80 L, 0.80 D, and 0.20 P. A new indicator may be created, such as “frequent L” or the only “ever L” may be kept as the only indicator. This example continues assuming the “ever L” state is sufficient.

Again, all the D or P portions need not be explicitly treated and can be carried over from time period to time period and newly D or P portions can be added. The 75 (C plus L) portion at the end of the 2^{nd} time period now results in the following at the end of the 3^{rd} time period: 52.80 C (51.20 clean current and 1.60 dirty current=0.80+0.60+0.20), 9.10 L, 5.60 D, and 7.50 P.

With the “ever L” indicator in the 4^{th} time period and forward, the following states are of interest: Clean C, Dirty C, L, D, and P, versus the 27 paths in the full Markov iteration approach.

In the case where the component life is more than 4 time periods, the number of paths may include multiple indicators, such as ever one time period L, ever two time periods L, multiple one time periods L, D, P, etc. Note that the number of paths that need to be captured in this approach may be capped by the number of indicators needed. At the same time, it may also be reasonable to assume the number of indicators needed should remain tractable, because once the component reaches 3 time periods or 4 time periods L, the component may be considered as D and the component will end.

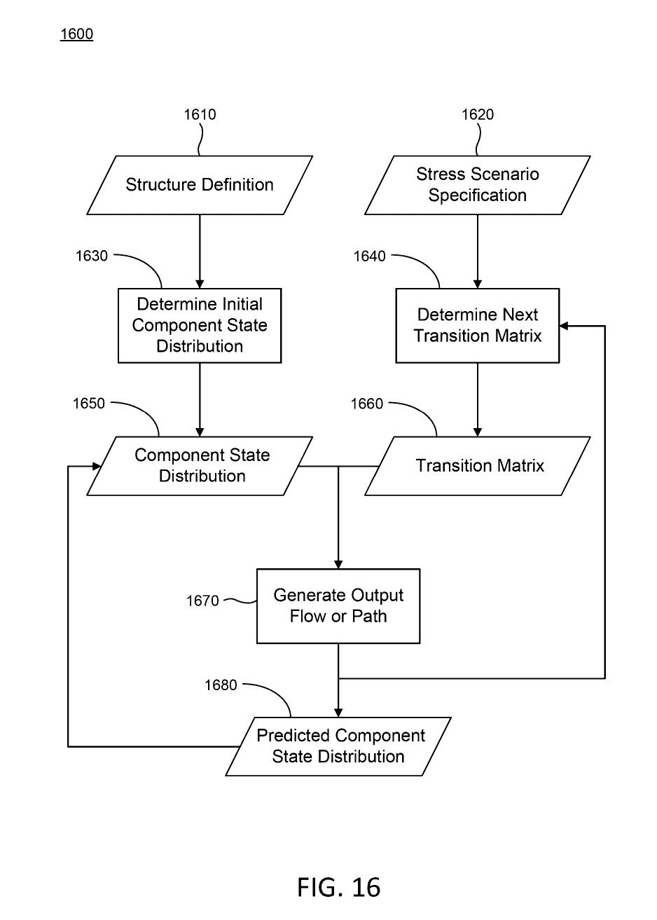

FIG. 16 provides an overview of a process for stress testing. Initially, a structure definition 1610 may be received or provided, such as a structure definition that identifies characteristics of components in the structure, such as characteristics including component states and component transition histories. Additionally, a stress scenario specification 1620 may be determined or provided, such as a stress scenario specification that provides time period dependent conditions that affect a change to one or more characteristics of components in the structure. Using the structure definition, the initial component state distribution may be determined, as illustrated by block 1630. An initial transition matrix may be determined using the stress scenario specification, as illustrated by block 1640, such as a transition matrix that includes transition intensities that correspond to a likelihood that a component of the structure will change from an initial component state to a future component state within one time period. The component state distribution 1650 and the transition matrix 1660 may be used to generate an output flow or output path, at block 1670, which may provide a predicted component state distribution 1680, which may correspond to a distribution of predicted future component states for the next time period and may reflect that the predicted component states may be dependent upon past component states. It will be appreciated that predicted component states may depend on a state path taken by the component at one or more previous time periods; for example, the predicted states at time period t+10 may be dependent upon the states and transitions between states at one or more of time periods t, t+1, t+2, . . . t+8, and t+9.

Following from generation of the output flow, at block 1670, transition matrices may be iteratively determined for the next time period to continue generation of the output flow for future time periods, such as by using the component state distribution in the next output flow generation iteration. It will be appreciated that multiple transition matrices may be generated for use in a single time period, such as to provide different transition intensities for components with different transition histories. It will further be appreciated that determination of a transition matrix may include identification of allowable transitions between each component state, as some initial component states may only be permitted to change to a subset of different future component states within one time period. Additionally, it will be appreciated that determination of a transition matrix may include identification of transition intensities for each allowable transition using the stress scenario specification, such as for the particular time period of interest, as well as the component transition histories.

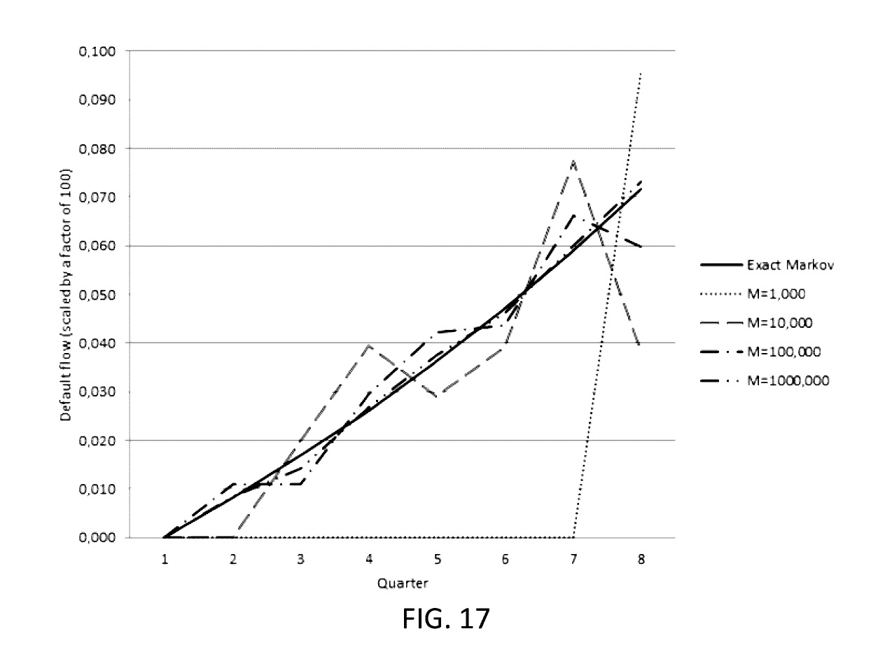

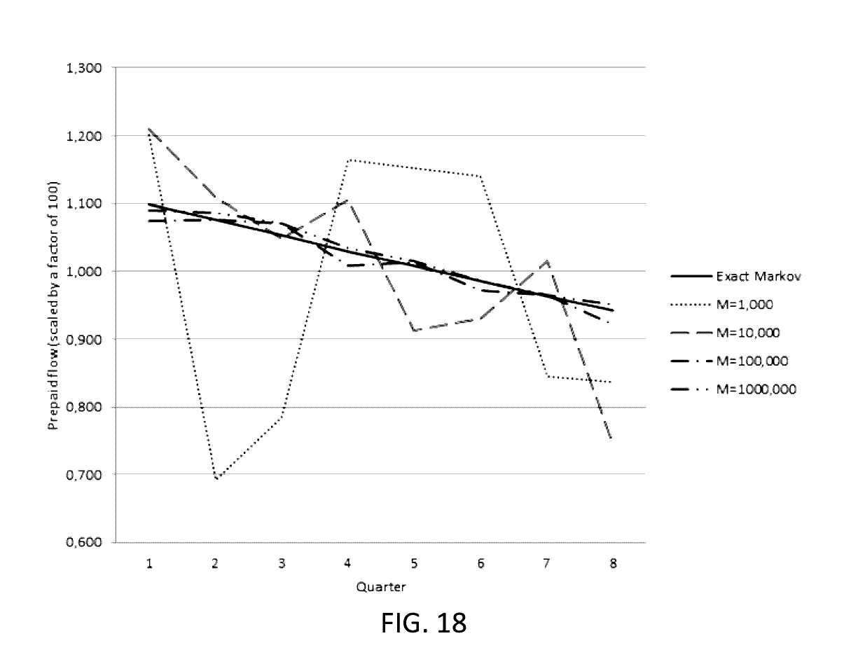

FIG. 17 provides a plot showing simulated output flows for one component state (default amounts) for a Markov case and a variety of simulation cases. FIG. 18 provides a plot showing simulated output flows for another component state (prepaid amounts) for a Markov case and a variety of simulation cases. These plots provide a comparison of the results of simulations and the exact Markov iteration approach, based on a quarterly model, showing how, by increasing the number of simulations, the output flows generally converge. The output flow using 1,000 simulations shows marked differences between the other simulation curves. It will be appreciated that as more and more simulations are performed, the output flow tends to converge, indicating that a higher quality result is achieved, which may be considered to be a more accurate prediction. However, increasing the number of simulations increases the computational burden, and so it may not be practical to perform a large number of simulations that would provide a more accurate output flow. It will be appreciated that, as the number of simulations are increased, the output flows tend to converge to that achieved by the Exact Markov approach, which may be considered to be the most accurate output flow prediction. It will further be appreciated that, aside from the present invention, a simulation-based approach using a large number of simulations may be considered to be one of the most accurate ways of predicting output flows.

The exact and reduced or simplified Markov approaches described above provide computationally efficient methods for determining output flows, such as output flows of high accuracy, that may otherwise only be achieved by performing an infinite or sufficiently large number of simulations. For example, the exact and reduced or simplified Markov approaches may take less time, processing resources, and or memory resources to compute as compared to performing simulations, even for low numbers of simulations. This may result in an improvement to the functioning of a computing system used to compute the output flows, as the exact and reduced or simplified Markov approaches may generate a more accurate output flow prediction in a shorter amount of computation time and use less memory as compared to other approaches, including a simulation-based output flow prediction approach. Further, it will be appreciated that the Markov approaches are not simulations, but instead provide an exact reproducible calculation, such as an exact analytical calculation, of the output flows based on the previous component state distributions, component state transition history and paths, stress scenario specifications, etc.

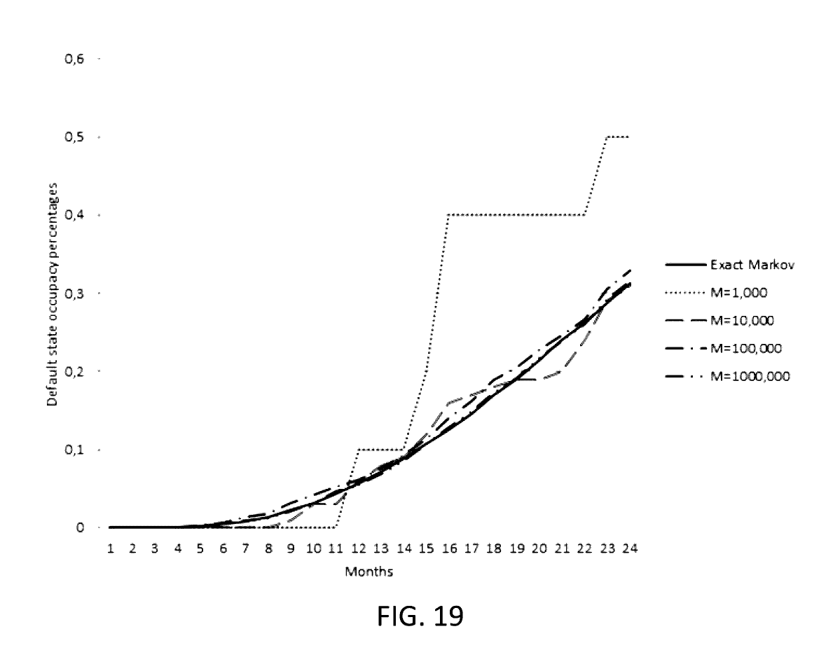

FIG. 19 provides a plot showing simulated output flows (default state occupancy) for one component state for a Markov case and a variety of simulation cases. Here, the predictions are made on a monthly basis over the course of 24 months, which may result in a significant increase of the number of cases which have to be computed for the exact Markov approach. The

Markov results shown, however, result from a simplified Markov iteration model where the number of months since last delinquent is not used to indicate state history, and instead only an indicator of ever delinquent 30 days is used. This simplification allows the Markov iteration model to be performed faster than even a small number of state transition simulations, and the results of the Markov calculation appear to approach those achieved by 1,000,000 simulations, illustrating the robustness and efficiency of the approach.

What is claimed is:

1. A stress testing system comprising:
one or more processors; and
a non-transitory computer readable storage medium including instructions that, when executed by the one or more processors, cause the one or more processors to perform operations including:
receiving a structure definition for a structure, wherein the structure includes a plurality of components, wherein the structure definition identifies characteristics of components in the structure, and wherein characteristics include a component state and a component transition history;
determining a stress scenario specification, wherein the stress scenario specification relates to time period dependent stress conditions that affect changes to characteristics;
iteratively determining transition matrices for each of a plurality of time periods and component transition histories using the stress scenario specification, wherein a transition matrix includes transition intensities, wherein a transition intensity corresponds to a likelihood that a component of the structure will change from an initial component state to a future component state within one time period, and wherein determining an individual transition matrix for a particular time period includes:
identifying allowable transitions between each component state; and
identifying transition intensities for each allowable transition using the stress scenario specification for the particular time period and the component transition histories;
determining an initial distribution of component states at an initial time, wherein determining includes using the structure definition; and
generating an output flow using the transition matrices and the initial distribution of component states, wherein the output flow provides a distribution of predicted future component states for each of the plurality of time periods.

2. The system of claim 1, wherein determining the stress scenario specification includes receiving the stress scenario specification.

3. The system of claim 1, wherein determining the stress scenario specification includes receiving a stress projection and generating the stress scenario specification using the stress projection.

4. The system of claim 3, wherein the stress projection provides macro-scale conditions for affecting the changes to characteristics of components of the structure and wherein generating the stress scenario specification includes identifying micro-scale conditions for affecting changes to characteristics of components of the structure.

5. The system of claim 1, wherein the stress scenario specification identifies predicted time period dependent stress conditions.

6. The system of claim 1, wherein a transition intensity is a transition probability.

7. The system of claim 1, wherein the transition matrices are dependent on component transition histories.

8. The system of claim 1, wherein determining an individual transition matrix includes:
generating a component state dependent transition model; and
determining transition intensities using the state dependent transition model and the stress scenario specification.

9. The system of claim 1, wherein iteratively determining individual transition matrices includes evaluating a Markov state transition model.

10. The system of claim 1, wherein determining an individual transition matrix includes generating a time dependent component state transition model using the stress scenario specification.

11. The system of claim 1, wherein a structure corresponds to a group of accounts.

12. The system of claim 1, wherein a component corresponds to an account.

13. The system of claim 1, wherein a component state identifies which of a plurality of conditions the component is associated with at a particular time.

14. The system of claim 1, wherein a component transition history identifies historical component states and transitions between states for the component.

15. The system of claim 1, wherein a component characteristic includes a value of a component.

16. The system of claim 1, wherein the output flow is used to facilitate determination of required reserves for a holder of the structure based on the definition of the structure and the stress scenario specification.

17. The system of claim 1, wherein the output flow is used to facilitate determination of predicted future values for one or more components of the structure.

18. The system of claim 1, wherein generating the output flow includes generating the output flow without requiring individual simulations of predicted future characteristics for each of the components of the structure.

19. The system of claim 1, wherein generating the output flow includes determining products of a first transition matrix corresponding to a first time period and the initial distribution of component states to generate a first distribution of characteristics for components of the structure after the first time period.

20. The system of claim 19, wherein generating the output flow includes determining products of a second transition matrix corresponding to a second time period and the first distribution of characteristics for components of the structure after the first time period to generate a second distribution of characteristics for components of the structure after the second time period.

21. The system of claim 1, wherein generating the output flow includes computing a Markov iteration for each of the plurality of time periods.

22. The system of claim 1, wherein the operations further include:
determining a time dependent growth rate, wherein generating the output flow includes using the time dependent growth rate, and wherein a time dependent growth rate provides rates at which a component characteristic increases over time.

23. The system of claim 1, wherein the operations further include:
determining a time dependent decay rate, wherein generating the output flow includes using the time dependent decay rate, and wherein a time dependent decay rate provides rates at which a component characteristic decreases over time.

24. A computer-program product tangibly embodied in a non-transitory machine-readable storage medium, including instructions configured to cause a computing device to perform operations including:
receiving, at the computing device, a structure definition for a structure, wherein the structure includes a plurality of components, wherein the structure definition identifies characteristics of components in the structure, and wherein characteristics include a component state and a component transition history;
determining a stress scenario specification, wherein the stress scenario specification relates to time period dependent stress conditions that affect changes to characteristics;
iteratively determining transition matrices for each of a plurality of time periods using the stress scenario specification and component transition histories, wherein a transition matrix includes transition intensities, wherein a transition intensity corresponds to a likelihood that a component of the structure will change from an initial component state to a future component state within one time period, and wherein determining an individual transition matrix for a particular time period includes:
identifying allowable transitions between each component state; and
identifying transition intensities for each allowable transition using the stress scenario specification for the particular time period and the component transition histories;
determining an initial distribution of component states at an initial time, wherein determining includes using the structure definition; and
generating an output flow using the transition matrices and the initial distribution of component states, wherein the output flow provides a distribution of predicted future component states for each of the plurality of time periods.

25. The computer-program product of claim 24, wherein determining the stress scenario specification includes receiving the stress scenario specification.

26. The computer-program product of claim 24, wherein determining the stress scenario specification includes receiving a stress projection and generating the stress scenario specification using the stress projection.

27. The computer-program product of claim 26, wherein the stress projection provides macro-scale conditions for affecting the changes to characteristics of components of the structure and wherein generating the stress scenario specification includes identifying micro-scale conditions for affecting changes to characteristics of components of the structure.

28. The computer-program product of claim 24, wherein the stress scenario specification identifies predicted time period dependent stress conditions.

29. The computer-program product of claim 24, wherein a transition intensity is a transition probability.

30. A computer implemented stress testing method, comprising:
receiving, at a computing device, a structure definition for a structure, wherein the structure includes a plurality of components, wherein the structure definition identifies characteristics of components in the structure, and wherein characteristics include a component state and a component transition history;
determining a stress scenario specification, wherein the stress scenario specification relates to time period dependent stress conditions that affect changes to characteristics;
iteratively determining transition matrices for each of a plurality of time periods using the stress scenario specification and component transition histories, wherein a transition matrix includes transition intensities, wherein a transition intensity corresponds to a likelihood that a component of the structure will change from an initial component state to a future component state within one time period, and wherein determining an individual transition matrix for a particular time period includes:
identifying allowable transitions between each component state; and
identifying transition intensities for each allowable transition using the stress scenario specification for the particular time period and the component transition histories;
determining an initial distribution of component states at an initial time, wherein determining includes using the structure definition; and
generating an output flow using the transition matrices and the initial distribution of component states, wherein the output flow provides a distribution of predicted future component states for each of the plurality of time periods.
